(19) United States
(12) Patent Application Publication
(10) Pub. No.: US 2017/0118739 A1
(43) Pub. Date: Apr. 27, 2017

(54) SYSTEM AND METHOD FOR ESTABLISHING A PAGING PROXY IN A WIDE AREA WIRELESS NETWORK

(71) Applicant: MOTOROLA MOBILITY LLC, Chicago, IL (US)

(72) Inventors: Wayne Ballantyne, Coconut Creek, FL (US); Roger W. Ady, Chicago, IL (US); Murali Narasimha, Vernon Hills, IL (US)

(21) Appl. No.: 14/920,279

(22) Filed: Oct. 22, 2015

(51) Int. Cl. H04W 68/02; H04W 12/06; H04W 76/04

(52) U.S. Cl. CPC H04W 68/02; H04W 76/04; H04W 12/06; H04W 84/04

(57) ABSTRACT

The present invention provides a system and method for establishing a paging proxy in a wide area wireless network. The system and method include detecting a proxy device for acting as a paging proxy near a present position of the mobile wireless communication device, where the proxy device includes a communication connection with a network paging controller, and is adapted to interact with the mobile wireless communication device separately from a wide area communication connection used by the mobile device to communicate with the wide area wireless network, where the proxy device is assigned to a particular tracking area. The mobile wireless communication device is then associated with the particular tracking area assigned to the proxy device for communicating paging messages to the mobile wireless communication device. A wireless receiver of the mobile wireless communication device used by the mobile wireless communication device to communicate with the wide area wireless network via a wide area communication connection is then deactivated. When a paging message intended for the mobile wireless communication device is to be delivered to the mobile wireless communication device having the deactivated wireless receiver, the wide area wireless network conveys the paging message through the particular tracking area associated with the mobile wireless communication device, to which the proxy device is assigned.

### FIELD OF THE INVENTION

The present invention relates generally to a system and method for managing a paging proxy for a mobile wireless communication device in a wide area wireless network, and more particularly, to the management of a proxy device relative to a newly established or already existing tracking area associated with the mobile wireless communication device.

### BACKGROUND OF THE INVENTION

One of the factors that make cellular communications via a wireless communication device desirable is the ability make a communication connection with less concerns as to your present location, where the same device can generally connect wirelessly to the network infrastructure with less restrictions as to location while within the boundaries of a coverage area that can include multiple base station transmission sites. This allows one an ability to be mobile and still retain the capabilities of making and maintaining a communication connection via the network infrastructure.

Portable wireless communication capabilities are not only supported by a wireless transmit and receive architecture that involves the ability to transmit and receive a communication signal over distance without a wired connection, but also typically involves some form of power local to the device that can be used to support the operation of electronic circuits used by the device for support of its various functions. More specifically, mobile stations are often conventionally powered by a depletable energy source, such as a battery. In many instances, an at least partially or substantially fully depleted battery can then be recharged to further extend the ability of the battery to provide power to the various electronic circuits of the device. However, in order to be recharged, the device often needs to find an outlet of a main supply for making a wired connection, wherein during the recharging, the mobility of the device can be significantly restricted.

Correspondingly, device users will often get into the habit of recharging their devices during the night when they are sleeping, and they are generally not very mobile, so that in the morning the device will have a full charge at the start of the day. It is further desirable for the charge to last as long as possible thereafter, where ideally the charge will last at least until they are ready to go asleep again the following night in order to minimize the need to recharge their device during the day, when they are generally more active. One potential solution might be to add a sufficiently large battery to support the functioning of the device over the desired period of time. However, there is an equally desired trend to minimize the overall size and weight of the device, where a larger battery will often contribute to an increase in the overall size and weight of the device. Still further, as more features are incorporated into the device, an increased number of power drawing components, such as circuits, are often necessary to support the increase in functionality.

As such, there is a balance between decreasing the amount of power necessary to support an existing function with the increased power requirements associated with adding new, enhanced, or additional functionality, as well as a balance with the size of the battery and the ability of the battery to store and subsequently supply power. One such technique that has been used to try and reduce overall power consumption involves the use of a periodic paging signal constrained to a specific, reduced portion of the overall control channel, which can be used to alert the mobile device of an incoming call or communication. When waiting for an alert of an incoming call, the receiver of the mobile device can be activated for these portions, and, unless otherwise actively communicating with the network infrastructure, can be deactivated during the other portions of the channel in which no signal of interest is expected. However even during these reduced portions of the overall control channels, incoming pages for a particular mobile device can be rare. Correspondingly, the mobile device is often waking up to receive a paging signal during many instances, where there is no incoming page to be received.

From a network perspective, restricting paging messages to a particular portion of the control channel already has the possibility of adding some latency to the actual delivery of the paging message. Furthermore, because the page does not utilize a guaranteed delivery method, it may be necessary to repeat the message one or more times. Still further, because the network may not know with reasonable certainty where a mobile device is located, the page is sent to a tracking area for broadcast that can include 100 or more eNB's or base station type nodes, which represents potentially significant network resources.

Correspondingly, the present inventors have recognized that it would be beneficial to establish a paging proxy for a particular mobile device, whereby the paging proxy is capable of communicating with the particular mobile device separate from the wide area wireless communication network. In connection with establishing a paging proxy, the proxy can be assigned to a tracking area, which is already or is then associated with the particular mobile device, such that the paging proxy can be included in the list of devices via which a paging message is to be attempted to be communicated to the mobile device.

### SUMMARY OF THE INVENTION

The present invention provides a method for establishing a paging proxy in a wide area wireless network. The method includes detecting a proxy device for acting as a paging proxy near a present position of the mobile wireless communication device, where the proxy device includes a communication connection with a network paging controller, and is adapted to interact with the mobile wireless communication device separately from a wide area communication connection used by the mobile device to communicate with the wide area wireless network. The proxy device is then assigned to a particular tracking area. The mobile wireless communication device is then associated with the particular tracking area assigned to the proxy device for communicating paging messages to the mobile wireless communication device. A wireless receiver of the mobile wireless communication device used by the mobile wireless communication device to communicate with the wide area wireless network via a wide area communication connection is then deactivated. When a paging message intended for the mobile wireless communication device is to be delivered to the mobile wireless communication device having the deactivated wireless receiver, the wide area wireless network conveys the paging message through the particular tracking area associated with the mobile wireless communication device, to which the proxy device is assigned.

The present invention further provides a paging controller of a wide area wireless network. The paging controller includes a tracking area management unit adapted for managing a group of one or more tracking areas. Each tracking area has one or more associated transmitters for conveying a paging message in the corresponding tracking area. The paging controller further includes a mobile device management unit adapted for managing the association of a particular mobile wireless communication device with one or more tracking areas, such that when a page for the particular mobile device is to be transmitted, the appropriate tracking areas within which the page should be transmitted can be identified. The paging controller still further includes a paging proxy management unit adapted for receiving a tracking area update request, where the tracking area update request includes a request that a proxy device be associated with paging messages for the particular mobile wireless communication device, whereupon confirmation of the proxy device, the tracking area management unit is instructed to add the proxy device to the tracking area associated with the particular mobile wireless communication device.

The present invention still further provides a mobile wireless communication device. The mobile wireless communication device includes a proxy detection unit adapted for detecting a proxy device having a communication connection with a network paging controller and which is adapted for acting as a paging proxy, that is near a present position of the mobile wireless communication device. The mobile wireless communication device further includes a tracking area update request unit adapted for requesting a tracking area update to an area which includes the detected nearby proxy device. The mobile wireless communication device still further includes a wireless receiver adapted for communicating with the wide area wireless network via a wide area communication connection including receiving a paging message from a wide area wireless network, which can be selectively activated and deactivated. The mobile wireless communication further yet includes a communication controller unit, which is adapted to selectively deactivate the wide area wireless communication receiver when a tracking area associated with the mobile wireless communication device has been updated to include the detected nearby proxy device; and adapted to selectively activate the wide area wireless communication receiver when the indication of a paging signal from the detected nearby proxy device is received.

Further yet, the present invention provides a proxy device for use in conveying an indication of an incoming paging signal. The proxy device includes a wide area wireless network communication unit adapted for communicating with the wide area wireless network. The proxy device further includes a local communication unit adapted for interacting with a nearby mobile wireless communication device including receiving an association request including a request for proxy paging services. The proxy device still further includes a paging unit adapted for receiving a paging signal alert for an associated mobile wireless communication device via the wide area wireless network communication unit, and forwarding an indication of an incoming paging signal to the associated mobile wireless communication device via the local communication unit. When an association request including a request for proxy paging services is received, the paging unit of the proxy device is adapted to communicate with the wide area wireless network for purposes of the proxy device becoming associated with the tracking area of the mobile wireless communication device.

These and other objects, features, and advantages of this invention are evident from the following description of one or more preferred embodiments of this invention, with reference to the accompanying drawings.

### BRIEF DESCRIPTION OF THE DRAWINGS

FIG. 1 is a block diagram of an exemplary network environment in which the present invention is adapted to operate;

FIG. 2 is a block diagram of a paging controller for use in a wide area wireless network, illustrated in FIG. 1;

FIG. 3 is a block diagram of a mobile wireless communication device for use in a wide area wireless network, illustrated in FIG. 1;

FIG. 4 is a block diagram of a proxy device for use in conveying an indication of an incoming paging signal for an associated one or more mobile wireless communication devices;

FIG. 5 is a flow diagram of a method for establishing a paging proxy in a wide area wireless network;

FIG. 6 is a flow diagram of a method of assigning the proxy device to a particular tracking area; and

FIG. 7 is a flow diagram of a method for verifying the validity of the credentials being used by the proxy device.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

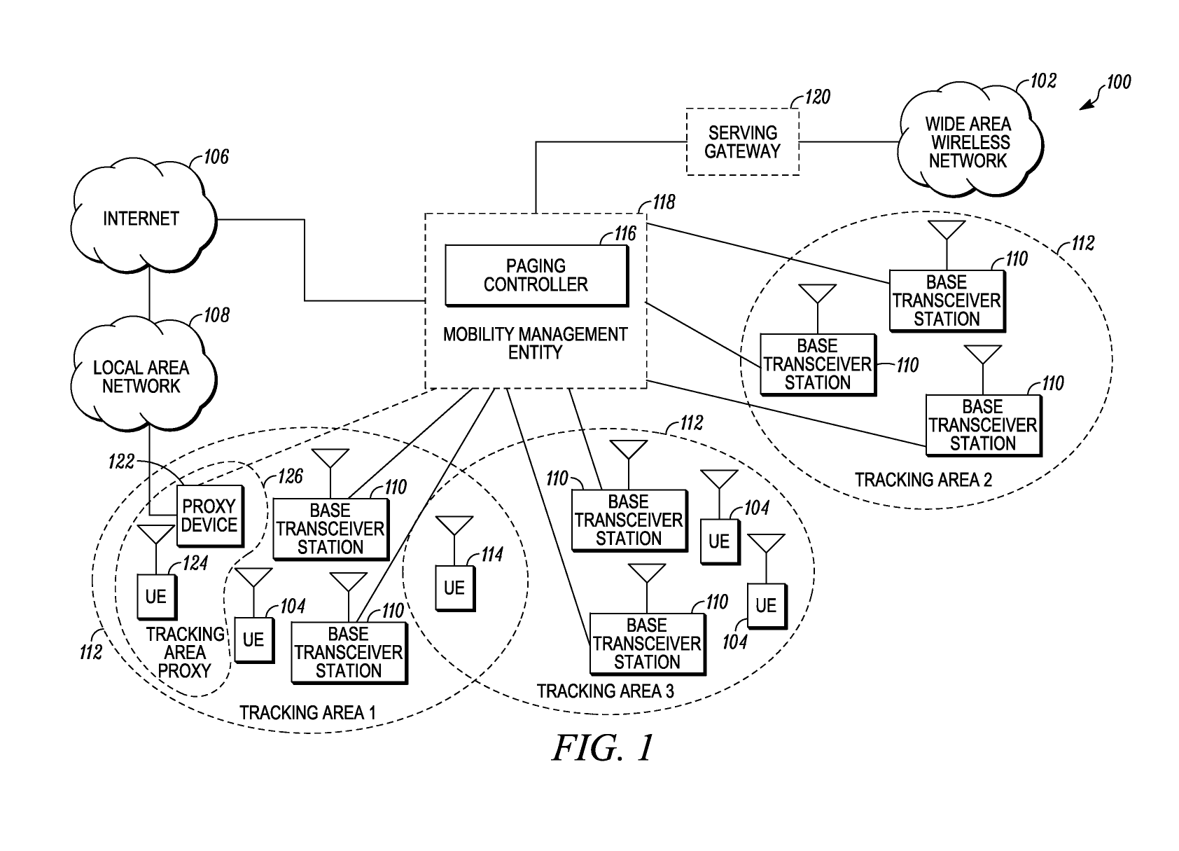

FIG. 1 illustrates a block diagram of an exemplary network environment 100 including a wide area wireless network in which a network infrastructure enables one or more mobile wireless communication devices 104, often referred to as user equipment (UE), to operate through wireless communications with the network and with each other. The illustrated exemplary network environment additionally includes the Internet 106, as well as one or more local area networks 108 of which some of the shown elements are a part and/or with which the shown elements can interact, either directly or indirectly.

In the illustrated embodiment, the wide area wireless network is a wireless cellular network, which includes geographically dispersed base transceiver stations 110, each base transceiver station generally corresponding to one or more cellular regions, which are then grouped into various tracking areas 112. Each tracking area 112 corresponds to the particular group of base transceiver stations 112 and/or cellular regions that will be used to relay a paging signal when a particular mobile wireless communication device needs to be alerted as to an incoming call or message. In other words, when a mobile wireless communication device 104 is in an idle state, i.e. not actively communicating with the network infrastructure 102 of the wide area wireless network 102, the network maintains the current location of the mobile wireless communication device 104 at a tracking area level of granularity, as opposed to a cell level of granularity. While in an idle state, the mobile wireless communication device 104 will periodically wake up to monitor a control channel to determine if there is a paging message for the device 104, which would alert the device 104 as to a need to establish a more dedicated communication connection between the mobile wireless communication device 104 and the wide area wireless network 102.

In some instances, a mobile wireless communication device 114 can be in an area of overlap and/or proximate a boundary relative to multiple tracking areas 112. In such an instance, a wide area wireless network 102 may associate multiple tracking areas 112 with a particular mobile wireless communication device 114. While the grouping of base transceiver stations 110 for paging purposes in some networks are referred to as tracking areas, in other instances it is possible for the tracking area to alternatively be referred to as location areas, routing areas, or registration areas.

The paging of mobile wireless communication devices 104, is generally managed by a paging controller 116, which in the illustrated embodiment is incorporated as part of a mobility management entity 118. The paging controller 116 initiates the paging procedure by sending a paging message to the base transceiver stations 110, which are part of the tracking area(s) associated with the target mobile wireless communication device 104. The base transceiver stations 110 then broadcasts the paging message to the corresponding cellular transmission areas of the base transceiver stations that are part of the associated tracking area(s).

In at least some instances, the mobility management entity 118 will communicate with the rest of the wide area wireless network 102 via a serving gateway 120. For example, while in the illustrated example, the paging controller is shown as having a direct connection to the Internet 106, in some instances the paging controller will couple to the Internet via the serving gateway 120 and the portions of the wide area wireless network 102, which are not specifically shown, such as via a packet data network gateway.

In the illustrated embodiment, a proxy device 122 is illustrated, which is intended to serve as an alternative method via which a paging message can be communicated to one or more mobile wireless communication device 124. The proxy device 122 is intended to communicate with the mobile wireless communication device 124 via an alternative approach distinguishable from the approach via which the base transceiver stations 110 will typically convey a paging message to a mobile wireless communication device 104. This in turn will enable the mobile wireless communication device to deactivate its wireless receiver, which is associated with the wide area wireless network 102, and which would otherwise be activated at least periodically for purposes of receiving a potentially present paging message. It is envisioned that the proxy device 122 will be able to communicate at least an indication of a paging message with the mobile wireless communication device 124 via an alternative approach which will enable the paging message to be received by the mobile wireless communication device 124 in a manner which is intended to require less overall power.

In some instances, the indication of a paging message will be conveyed using a lower power form of wireless communication, which may require that the proxy device 122 be relatively closer to the corresponding mobile wireless communication device 124. For example, the proxy device 122 might communicate with the mobile wireless communication device 124 via a low power form of communication, such as Bluetooth Low Energy, infra red, Near Field Communication (NFC), or Radio Frequency Identification (RFID). In other instances, it may be necessary for the mobile wireless communication device 124 to be in physical contact with the proxy device 122. In instances where the mobile wireless communication device 124 is in physical contact with the proxy device 122, a vibrational source within the proxy device 122, such as a linear vibrator device or unbalanced mass vibrator, and a vibrational detector within the mobile wireless communication device 124, such as an accelerometer could be present for use in conveying a message, such as an indication of an incoming paging message, through the use of a distinctive vibrational pattern, which could be detected through the physical contact. In at least some instances, the accelerometer will be a part of a suite of sensors present in the mobile wireless communication device 124, which are adapted for detecting the relative movement of the device. In some instances, the manner in which the proxy device 122 communicates with the mobile wireless communication device 124 will be via a method that enables an interrupt based form of communication, which allows the communication to occur without requiring the mobile wireless communication device 124 to be actively or periodically listening for the communication.

While it is possible that the proxy device 122 could communicate with the paging controller 116 via a same or similar manner in which the paging controller 116 communicates paging messages to the base transceiver stations 110 for being broadcast in the corresponding tracking areas 112, it is envisioned that in some instances, the proxy device 122 will be coupled to the paging controller 116 via a broadband type connection. A broadband type connection in the present context refers to a type of connection over a backbone network which can include cable, optical and possible fixed wireless type communication links. A broadband type connection can include an Internet connection, which can be established via a local area network 108, such as through a local router using Ethernet for example, and/or a wireless LAN connection.

In order to support the conveyance of an indication of a paging message via a proxy device 122 for a particular mobile wireless communication device 124, the paging proxy can be added to an already existing tracking area 112, that is currently associated with the particular mobile wireless communication device 124, or can be added to a newly created tracking area 126, which can then be associated with the particular mobile wireless communication device 124.

A new tracking area can be created in such a way that when the paging proxy device 122 is established, the paging proxy device 122 can be the focus of future paging activities relative to the particular mobile wireless communication device 124. For example, this could be achieved by creating a new tracking area 126, which is associated with the mobile wireless communication device 124 where the proxy device 122 is the only member of the new tracking area 126. In turn this will avoid attempts by other base transceiver stations 110 to send a paging message to the mobile wireless communication device 124, especially where the wide area wireless receiver of the mobile wireless communication device 124 is known to have been deactivated, and any paging of the mobile wireless communication device 124 that might have been attempted by the one or more base transceiver stations 110 could not have been received. In this way, the wireless communication resources that may have been used in an attempt to send a paging message to the mobile wireless communication device 124 could be used for an attempt to send a paging message to another different device. However, in such an instance, it may be beneficial for the indication of a paging message that might be sent by the proxy device 122 to include a transmission of the paging message.

Alternatively, where the proxy device 122 is added to an already existing tracking area 112, an indication of a paging message for a particular mobile wireless communication device 124 might be used by the proxy device 122 to provide an alert to the mobile wireless communication device 124 of the presence of a paging message of interest. The mobile wireless communication device 124 could then reactivate its wireless receiver, so that a subsequent transmission of the paging message by a base transceiver station 110 could then be received. However, in such an instance, it is also possible that the indication of a paging message could include the paging message, thereby precluding the need to monitor for and receive a subsequent transmission of the message.

Furthermore, in instances where a newly created tracking area 126 is established to support the use of the proxy device 122 in sending a paging message to the mobile wireless communication device 124, it may be beneficial to allow for a backup tracking area, that could be used in the event that all attempts to contact the mobile wireless communication device 124 via the proxy device 122 have been exhausted without a response confirming receipt by the mobile wireless communication device 124 of the paging message or an indication thereof. For example, if the device 124 has moved out of communication range of the proxy device 122, attempts to contact the device via the proxy device 124 will fail. In such an instance, the backup tracking area would likely be the tracking area associated with the mobile wireless communication device 124 prior to the establishment of a tracking area 126 for a device 124 to be used as a paging proxy. For example relative to mobile wireless communication device 124, tracking area 1 in FIG. 1 might serve as a backup paging area.

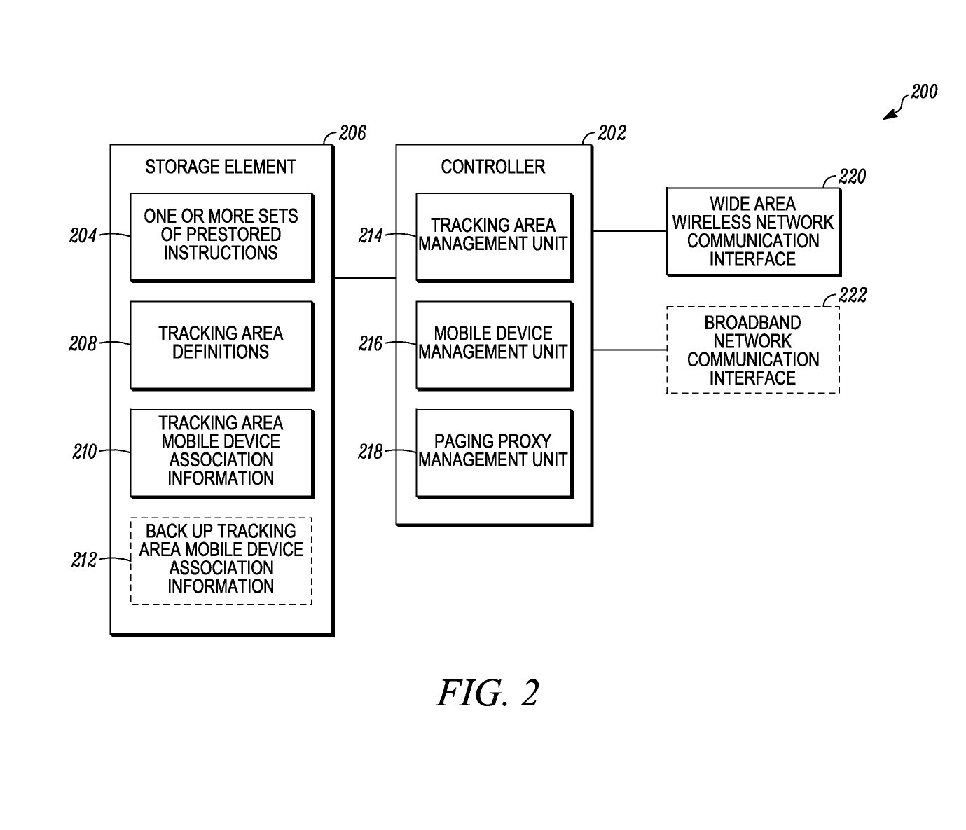

FIG. 2 illustrates a block diagram 200 of a paging controller 116 for use in a wide area wireless network, illustrated in FIG. 1. In at least some instances, as noted previously, the paging controller 116 can be incorporated as part of a mobility management entity 118. However, it is also possible that the paging controller 116 could be incorporated in another network element, or could be a standalone element. In the illustrated embodiment, the paging controller 116 includes a controller 202 or processor, which is adapted for managing at least some of the operation of the device. In some embodiments, the controller 202 could be implemented in the form of one or more microprocessors, which are adapted to execute one or more sets of pre-stored instructions 204, which may be used to form or implement the operation of at least part of one or more controller modules. The one or more sets of pre-stored instructions 204 may be stored in a storage element 206, which while shown as being a separate element could also be integrated as part of the controller 202, which may additionally or alternatively include some data storage capability for storing at least some of the prestored instructions for use with the controller 202.

The storage element 206 could include one or more forms of volatile and/or non-volatile memory, including conventional ROM, FLASH, EPROM, RAM, or EEPROM. The data storage capabilities may also include one or more forms of auxiliary storage, which is either fixed or removable, such as a hard drive, a floppy drive, or a memory stick. One skilled in the art will still further appreciate that still other further forms of storage elements could be used without departing from the teachings of the present disclosure. In the same or other instances, the controller 202 may additionally or alternatively incorporate state machines and/or logic circuitry, which can be used to implement at least partially, some of the modules and/or functionality associated with the controller 202.

In addition to the one or more sets of prestored instructions 204, the storage element 206 can additionally include tracking area definitions 208, which in conjunction with a tracking area management unit 214 of the controller 202, serves to identify the specific entities forming each of the tracking areas, wherein when a paging message needs to be communicated within a particular tracking area 112, the paging controller 116 knows which network entities, such as predefined groups of base transceiver stations need to be contacted for broadcasting the paging message. The storage element 206 can further include tracking area mobile device association information 210, which in conjunction with a mobile device management unit 216 of the controller 202, serves to link a particular mobile wireless communication device 104 with one or more particular tracking areas 112, such that when a paging message is intended for a particular mobile wireless communication device 104, the paging controller 116 can determine which tracking area(s) 112 to use. Still further, the storage element 206 can include back up tracking area mobile device association information 212, which supports additional tracking areas that might be associated with a particular mobile wireless communication device should an attempt to contact a mobile wireless communication device via the primarily associated tracking area(s) fail.

A paging proxy management unit 218 of the controller 202 is adapted for receiving tracking area update requests, where a corresponding request can include that a proxy device be associated with paging messages for a particular mobile wireless communication device 124. In connection with such a request, the proxy device 122 can be added to an already existing tracking area 112, or to a newly created tracking area 126. The tracking area associated with the mobile wireless communication device 124 can then be updated, if necessary, to reflect an association with the tracking area 112 or 126 that includes the proxy device 122.

When a request is received to associate a paging proxy device 122 with a particular mobile wireless communication device 124, it may be desirable for the paging controller 116 to be able to verify the validity of such a request including whether the request is acceptable to any affected mobile wireless communication devices 124. In order for the network to verify that the request is valid, the paging controller 116 may require that the proxy device 122 be identified by the mobile wireless communication device 124 as being authorized to act as a proxy for purposes of paging on behalf of the mobile wireless communication device 124. The paging controller 116 may further require that the proxy device 122 properly respond to a challenge response mechanism that confirms the credentials being used by the proxy device 122. More specifically, an authentication challenge could be generated wherein the proper response requires that it be based upon the credentials stored in a subscriber identity module associated with the corresponding mobile wireless communication device 124. Correspondingly, an authentication challenge could be received from the paging controller 116 by the affected mobile wireless communication device 124 via the proxy device 122. An authentication response could then be generated based upon the credentials in the subscriber identity module associated with the mobile wireless communication device 124. An authentication response could then be delivered to the paging controller 116 via the proxy device 122, where the response could be determined to be valid or not. In this way, the chances of an unauthorized attempt by a proxy device 122 to establish itself as a paging proxy device 122 for a particular mobile wireless communication device 124 can be reduced. It is further possible that the communications associated with verification of the proxy device 122 be secure and encrypted. In fact, in at least some instances, the communications between the mobile wireless communication device 124 and the proxy device 122 should be secure and encrypted, because this is where the security credentials of the mobile wireless communication device 124 to at least some degree are exposed to the proxy device 122.

The paging controller 116 further includes a wide area wireless network communication interface 220 via which the paging controller 116 can communicate with other network entities, such as the one or more base transceiver stations 110 as part of one or more tracking areas 112 via which a paging message can be communicated. The paging controller 116, in at least some instances, can additionally include a broadband network communication interface 220, such as an interface for communicating via a packet data network (i.e. the Internet 106), which may be separate from the wide area wireless network communication interface 220.

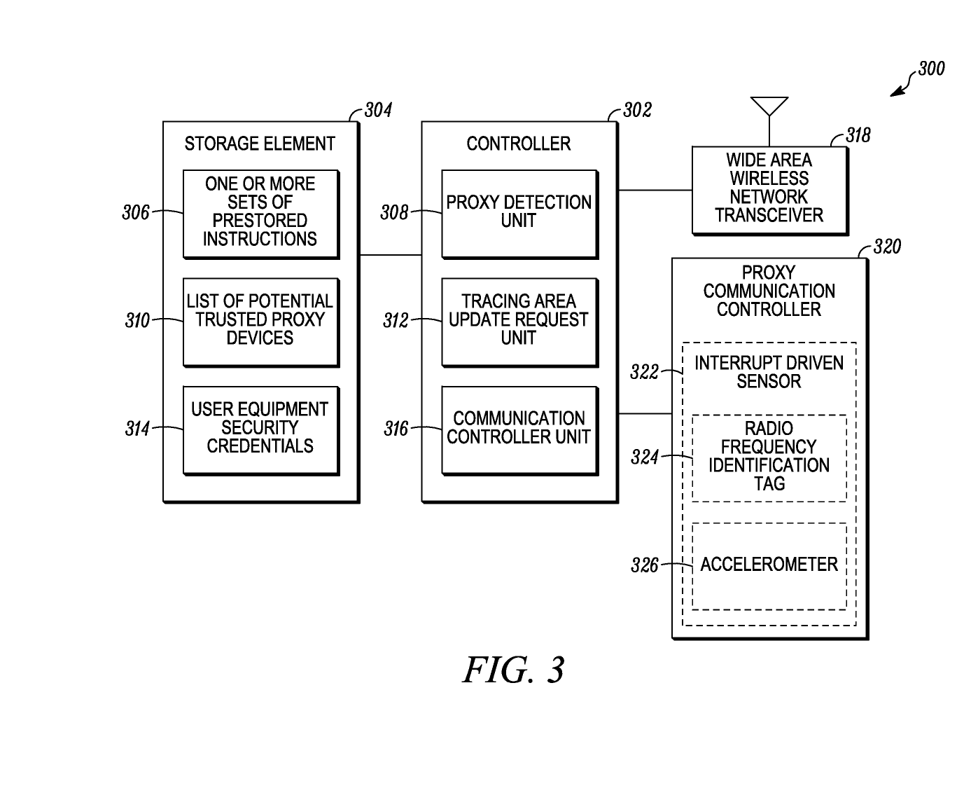

FIG. 3 illustrates a block diagram 300 of a mobile wireless communication device 124 for use in a wide area wireless network 102, illustrated in FIG. 1. Examples of a mobile wireless communication device 124 can include a radio frequency telephone, a tablet, a personal computer, a cellular telephone, a cordless telephone, a smartphone, a selective call receiver, an audio player, a gaming device, a set top box and a personal digital assistant. However one skilled in the art will appreciate that the present invention could also be used with many other types of devices, without departing from the teachings of the present invention, as increasingly more and more devices are being equipped with wireless communication capabilities for which the present application may be suitable including instances where it is desirable for the device to communicate within a wide area wireless network, where it may be helpful to be able to alert the mobile wireless communication device of an incoming communication.

Similar to the paging controller 116, the mobile wireless communication device 124 includes a controller 302 or processor, which is adapted for managing at least some of the modem-related operation of the device, and a storage element 304, which could be used for storing one or more sets of pre-stored instructions 306 for use by the controller 302 as well as other information that might be used in managing at least some of the operation of the device. More specifically, the controller 302 includes a proxy detection unit 308, which is adapted for detecting the presence of a device that is capable and agreeable to operating as a proxy device 122 in support of paging operations for the mobile wireless communication device 124. Associated with detecting a suitable proxy device 122, the proxy detection unit 308 could maintain and use a list of potential trusted proxy devices 310, which could be located in the storage element 304.

In the illustrated embodiment, the controller 302 additionally includes a tracking area update request unit 312, which is adapted to requesting a change in the one or more tracking areas 112 and/or 126 to be associated with the mobile wireless communication device 124. The change in the one or more associated tracking area is adapted to account for any change resulting from the potential use of a paging proxy device 122. As noted previously, the use of a paging proxy device 122 could result in a verification process to ensure that the requested change relative to tracking areas is authorized. In connection with such a verification, the storage element 304 is additionally adapted to include user equipment security credentials 314, such as the type found in a subscriber identity module, which may form all or parts of the storage element 304.

Still further, the controller 302 includes a communication controller unit 316, which is adapted to selectively activate and deactivate a wide area wireless network transceiver 318, as well as a proxy communication controller 320 depending upon whether the mobile wireless communication device 124 is intending to make more active use of a paging proxy device 122, or not. The proxy communication controller 320 is adapted to manage the interaction between the mobile wireless communication device 124 and the proxy device 122 including communications, which are separate from a wide area wireless network communication connection that supports a more direct communication with the wide area wireless network 102. In at least some instances, the separate form of communication managed by the proxy communication controller will include in the mobile wireless communication device 124 an interrupt driven sensor 322. Examples of an interrupt driven sensor 322 include a radio frequency identification tag 324, which is adapted to interact with a nearby RFID tag reader that could be incorporated into a proxy device 122, or a device which can detect a nearby vibration having a discernible pattern, such as an accelerometer 326. Where a vibration is to be detected, it is likely that the mobile wireless communication device 124 would need to be in physical contact either directly or indirectly with the source of the vibration.

Similar to the controller 202 of the paging controller 116, illustrated in FIG. 2, in at least some embodiments, the controller 302 of the mobile wireless communication device 124 could be implemented in the form of one or more microprocessors, which are adapted to execute the one or more sets of pre-stored instructions 306, which may be used to form or implement the operation of at least part of the one or more controller modules. While the storage element 304, which can include the one or more sets of pre-stored instructions 306, are shown as being a separate element, the storage element 304 could also at least partially be integrated as part of the controller 302, which may additionally or alternatively include some data storage capability for storing at least some of the prestored instructions for use with the controller 302. The controller 302 may additionally or alternatively incorporate state machines and/or logic circuitry, which can be used to implement at least partially, some of the modules and/or functionality associated with the controller 302.

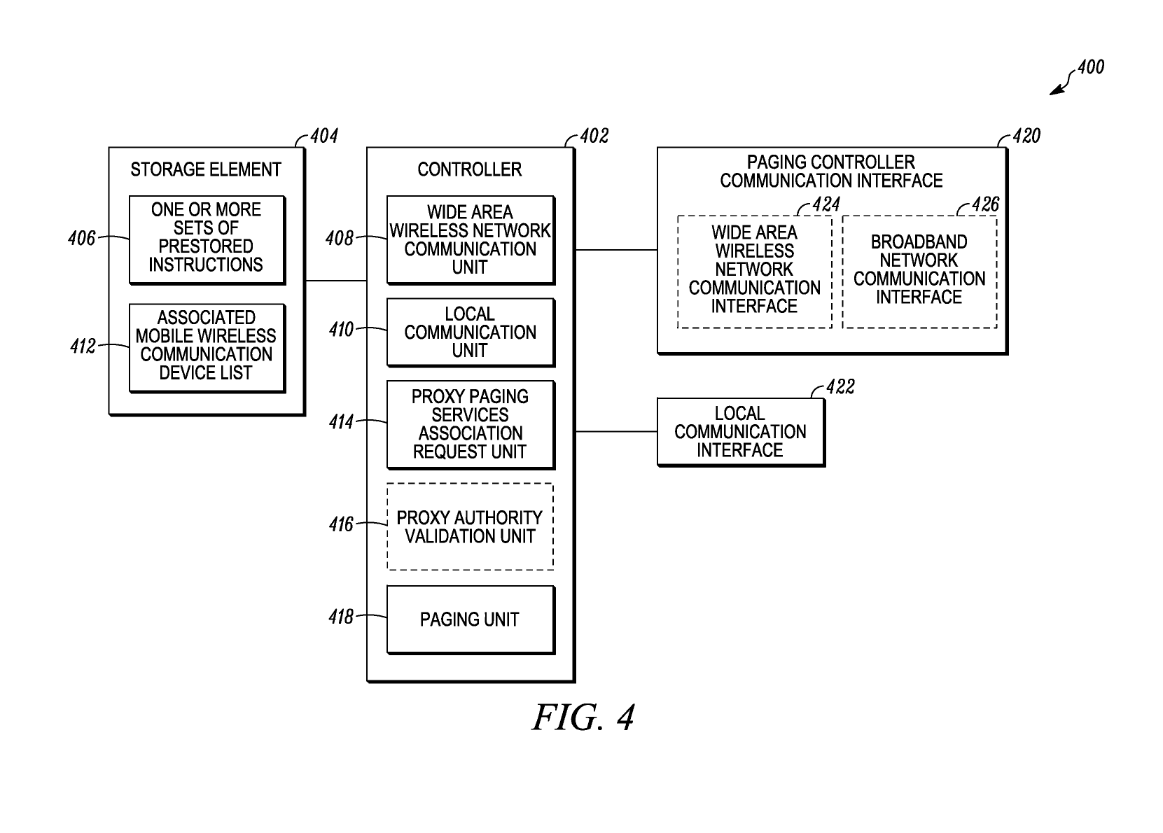

FIG. 4 illustrates a block diagram 400 of a proxy device 122 for use in conveying an indication of an incoming paging signal for an associated one or more mobile wireless communication devices 124. The proxy device 122 can involve a device capable of communicating with the paging controller 116 for receiving an indication of a paging message for one or more associated mobile wireless communication devices 124. In some instance, examples of the proxy device 122 can include a wireless local area network router, such as a Wi-Fi router. In other instances, examples of the proxy device can include a wireless charging station. In still further instances, the proxy device can be a wireless payment terminal or even another mobile wireless communication device.

Similar to the paging controller 116 and the mobile wireless communication device 124, the proxy device 122 includes a controller 402 or processor, which is adapted for managing at least some of the operation of the proxy device 122, and a storage element 404, which could be used for storing one or more sets of pre-stored instructions 406 for use by the controller 402 as well as other information that might be used in managing at least some of the operation of the proxy device 122. More specifically, the controller 402 includes a wide area wireless network communication unit 408, which is adapted for managing the communications between the proxy device 122 and the wide area wireless network 102 including the paging controller 116. The controller further includes a local communication unit 410, which is adapted for interacting with the nearby mobile wireless communication device(s) via a communication connection that is separate from the wide area communication connection used by the mobile wireless communication device 124 to communicate with the wide area wireless network 102. The proxy device 122 is adapted to receive a request for proxy paging services from a mobile wireless communication device 124 via the local communication unit 410, wherein upon receipt of such a request, a proxy paging services association request unit 414 of the controller 402 can be used to facilitate the proxy device 122 becoming associated with the mobile wireless communication device 124 for purposes of receiving and conveying a receipt of an indication of a paging message for an associated mobile wireless communication device(s). A list 412 of mobile wireless communication devices associated with the particular proxy device 122 can be maintained and updated, as necessary, in the storage element 404.

In at least some instances, as part of the becoming associated with a mobile wireless communication device, the controller 402 can include a proxy authority validation unit 416, which is adapted to verify the authority of the proxy device 122 to provide paging proxy services on behalf of the mobile wireless communication device 122 for which an association request is being made. In at least some instances, the proxy authority validation unit 416 will manage secure and encrypted communications between the proxy device 122, the mobile wireless communication device 124 and the paging controller 116, whereby credentials derived from information stored in the subscriber identity module of the mobile wireless communication device 124 can be conveyed to the paging controller 116 to verify the authority of the proxy device 122 to act as a paging proxy on behalf of the mobile wireless communication device 124.

The controller 402 of the proxy device 122 further includes a paging unit 418, which is adapted for receiving a paging signal alert for an associated mobile wireless communication device 124 via the wide area wireless network communication unit 408, which interfaces with the paging controller 116 via a paging controller communication interface 420. The paging unit 418 is further adapted for forwarding an indication of an incoming paging signal to the associated mobile wireless communication device 124 via the local communication unit 410, which interfaces with the same via a local communication interface 422. In some instances, the indication of an incoming paging signal which is relayed to the associated mobile wireless communication device 124 will include the paging message. In other instances, the indication of an incoming paging signal which is relayed to the associated mobile wireless communication device 124 will prompt the associated mobile wireless communication device 124 to reactivate its wide area wireless network transceiver 318, so that the mobile wireless communication device 124 can receive a subsequent paging message transmission more directly from the wide area wireless network 102.

In some instances, the paging controller communication interface 420 will include a wide area wireless network communication interface 424 via which the indication of a paging message for any and all associated mobile wireless communication devices can be received from the paging controller 116. The wide area wireless network communication interface 424 could receive messages from the paging controller 116 similar to the manner in which a base transceiver station 110 in a tracking area 112 will receive an indication of a paging message for broadcasting in the respective tracking area 112. In some instances, the paging controller communication interface 420 will include a broadband network communication interface 426 via which the indication of a paging message for any and all associated mobile wireless communication devices can be received from the paging controller 116. As noted previously, a broadband type connection in the present context refers to a type of connection over a backbone network which can include cable, optical and possibly fixed wireless type communication links, and can include an Internet or an Internet type (i.e. packet data) connection.

Similar to the controller 202 of the paging controller 116, illustrated in FIG. 2, and the controller 302 of the mobile wireless communication device 124, illustrated in FIG. 3, in at least some embodiments, the controller 402 of the proxy device 122 can be implemented in the form of one or more microprocessors, which are adapted to execute the one or more sets of pre-stored instructions 406, which may be used to form or implement the operation of at least part of the one or more controller modules. While the storage element 404, which can include the one or more sets of pre-stored instructions 406, are shown as being a separate element, the storage element 404 could also at least partially be integrated as part of the controller 402, which may additionally or alternatively include some data storage capability for storing at least some of the prestored instructions for use with the controller 402. The controller 402 may additionally or alternatively incorporate state machines and/or logic circuitry, which can be used to implement at least partially, some of the modules and/or functionality associated with the controller 402.

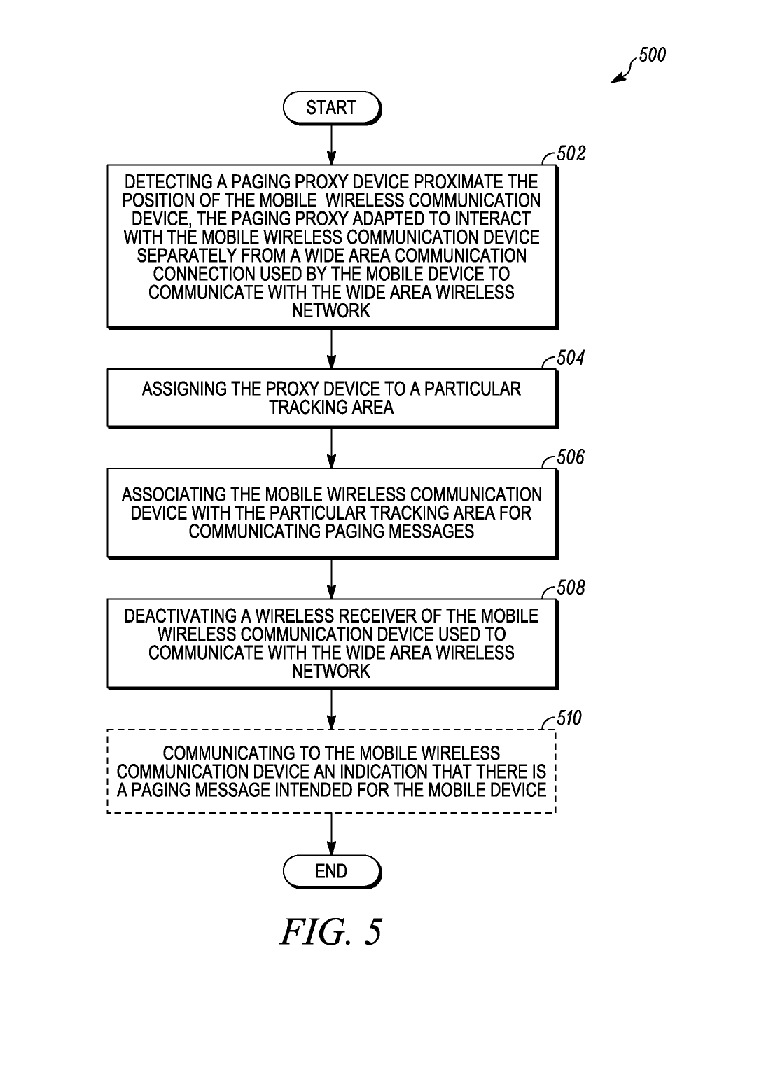

FIG. 5 illustrates a flow diagram 500 of a method for establishing a paging proxy in a wide area wireless network. The method includes detecting 502 a proxy device 122 for acting as a paging proxy near a present position of the mobile wireless communication device 124, where the proxy device 122 includes a communication connection with a network paging controller 116, and is adapted to interact with the mobile wireless communication device 124 separately from the wide area communication connection used by the mobile wireless communication device 124 to communicate with the wide area wireless network 102. The method then further includes the proxy device 122 being assigned 504 to a particular tracking area 112 or 126. The mobile wireless communication device 124 is then associated 506 with the particular tracking area assigned to the proxy device 122 for communicating paging messages to the mobile wireless communication device 124. A wireless receiver 318 used by the mobile wireless communication device 124 to communicate with the wide area wireless network 102 via a wide area communication connection is then deactivated 508, such that when a paging message intended for the mobile wireless communication device 124 is to be delivered to the mobile wireless communication device having the deactivated wireless receiver 318, the wide area wireless network 102 conveys the paging message through the particular tracking area 112 or 126 associated with the mobile wireless communication device, to which the proxy device 122 is assigned. An indication that there is a paging message intended for the mobile wireless communication device 124 can then be communicated 510 by the proxy device 122 to the mobile wireless communication device 124.

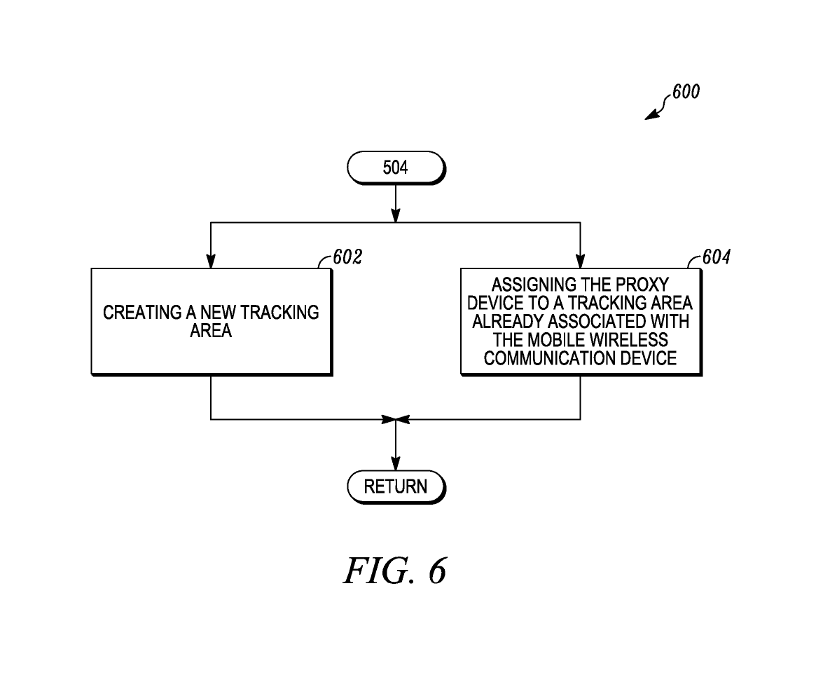

FIG. 6 illustrates a flow diagram 600 of a method of assigning the proxy device 122 to a particular tracking area 112 or 126. More specifically, the proxy device 122 can be added 602 to a newly created tracking area 126, or the proxy device 122 can be assigned 604 to the tracking area 112 already associated with the mobile wireless communication device 124.

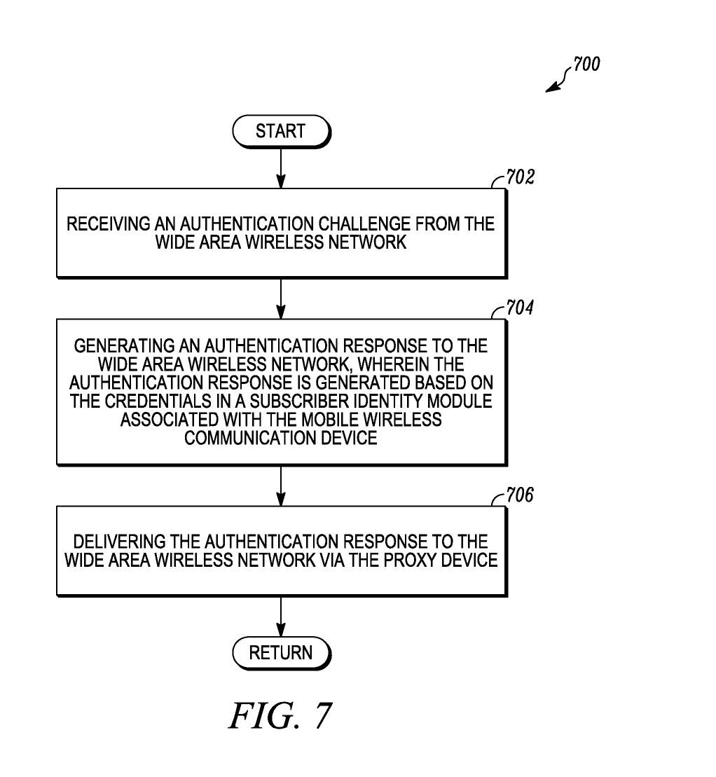

FIG. 7 illustrates a flow diagram 700 of a method for verifying the validity of the credentials being used by the proxy device 122, which can be performed after a paging proxy device 122 is detected 502, but before the paging proxy device 122 is assigned 504 to a particular tracking area 112 or 126. Such a verification can be performed to ensure that the proxy device is authorized to act as a paging proxy on behalf of the mobile wireless communication device.

More specifically, the verification of the validity of the credentials being used by the proxy device 122 includes the mobile wireless communication device 124 receiving 702 an authentication challenge from the wide area wireless network 102 via the proxy device 122. An authentication response to the wide area wireless network 102 is then generated 704, wherein the authentication response is generated based on the credentials stored in the mobile wireless communication device, such as in a subscriber identity module associated with the mobile wireless communication device 124. The authentication response is then delivered 706 to the wide area wireless network 102 via the proxy device 122. In this way, the wide area network 102 can be better assured that the proxy device 122 is acting under authority from the mobile wireless communication device 124.

By using a paging proxy, a mobile wireless communication device can maintain its wide area wireless network transceiver in a deactivated state for even longer periods of time during which it might be receiving a paging message from the wide area wireless network, in favor of a lower power for of alert for receiving an indication of an incoming paging message. In this way, the amount of power used by a mobile wireless communication device during idle mode may be further reduced.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method for establishing a paging proxy in a wide area wireless network, the method comprising:
detecting a proxy device for acting as a paging proxy near a present position of the mobile wireless communication device, where the proxy device includes a communication connection with a network paging controller, and is adapted to interact with the mobile wireless communication device separately from a wide area communication connection used by the mobile device to communicate with the wide area wireless network;
assigning the proxy device to a particular tracking area;
associating the mobile wireless communication device with the particular tracking area assigned to the proxy device for communicating paging messages to the mobile wireless communication device; and
deactivating a wireless receiver of the mobile wireless communication device used by the mobile wireless communication device to communicate with the wide area wireless network via a wide area communication connection;
wherein when a paging message intended for the mobile wireless communication device is to be delivered to the mobile wireless communication device having the deactivated wireless receiver, the wide area wireless network conveys the paging message through the particular tracking area associated with the mobile wireless communication device, to which the proxy device is assigned.

2. A method in accordance with claim 1 further comprising the proxy device communicating to the mobile wireless communication device an indication that there is a paging message intended for the mobile wireless communication device, the indication being communicated separate from the wide area communication connection associated with the wide area wireless network, in response to the wide area wireless network conveying the paging message through the particular tracking area associated with the mobile wireless communication device, to which the proxy device is assigned.

3. A method in accordance with claim 2, wherein communicating the indication that there is a paging message intended for the mobile wireless communication device includes communicating the paging message to the mobile wireless communication device via the proxy device.

4. A method in accordance with claim 2, wherein when the indication that there is a paging message intended for the mobile wireless communication device is received by the mobile wireless communication device via the proxy device, the mobile wireless communication device activates the wireless receiver of the mobile wireless communication device for communicating with the wide area wireless network via a wide area communication connection, and establishes a wide area communication connection with the wide area wireless network.

5. A method in accordance with claim 4, wherein the proxy device communicates the indication that there is a paging message for the mobile wireless communication device to the mobile wireless communication device via an interrupt based form of communication, wherein the interrupt based form of communication produces an interrupt driven activation of the wireless receiver in the mobile wireless communication device.

6. A method in accordance with claim 1, wherein assigning the proxy device to a particular tracking area includes creating a new tracking area, which is assigned to the proxy device.

7. A method in accordance with claim 1, wherein assigning the proxy device to a particular tracking area includes assigning the proxy device to a tracking area already associated with the mobile wireless communication device.

8. A method in accordance with claim 1, wherein as part of assigning the proxy device to a particular tracking area, a controller of the wide area wireless network verifies the validity of credentials being used by the proxy device.

9. A method in accordance with claim 8, wherein the credentials being used by the proxy device includes credentials associated with the mobile wireless communication device for which the proxy device will be serving as a paging proxy.

10. A method in accordance with claim 8, wherein the verification of the validity of the credentials being used by the proxy device comprises:
receiving an authentication challenge from the wide area wireless network via the proxy device;
generating an authentication response to the wide area wireless network, wherein the authentication response is generated based on the credentials in a subscriber identity module associated with the mobile wireless communication device for which the proxy device will be serving as a paging proxy; and
delivering the authentication response to the wide area wireless network via the proxy device.

11. A paging controller of a wide area wireless network comprising:
a tracking area management unit adapted for managing a group of one or more tracking areas, each tracking area having one or more associated transmitters for conveying a paging message in the corresponding tracking area;
a mobile device management unit adapted for managing the association of a particular mobile wireless communication device with one or more tracking areas, such that when a page for the particular mobile device is to be transmitted, the appropriate tracking areas within which the page should be transmitted can be identified;
a paging proxy management unit adapted for receiving a tracking area update request, where the tracking area update request includes a request that a proxy device be associated with paging messages for the particular mobile wireless communication device, whereupon confirmation of the proxy device, the tracking area management unit is instructed to add the proxy device to the tracking area associated with the particular mobile wireless communication device.

12. A paging controller of a wide area wireless network in accordance with claim 11, wherein confirmation of the proxy device includes verification of the credentials of the proxy device included as part of the tracking area update request.

13. A paging controller of a wide area wireless network in accordance with claim 11, wherein adding the proxy device to the tracking area associated with the particular mobile wireless communication device includes associating the particular mobile wireless communication device with a newly created tracking area.

14. A paging controller of a wide area wireless network in accordance with claim 11, wherein a tracking area including the proxy device is associated with mobile wireless communication device as a primary tracking area, and where the mobile device management unit further associates the mobile wireless communication device with a backup tracking area; and wherein when the mobile wireless communication device is paged by the paging controller through the primary tracking area, if there is no response to the page from the mobile wireless communication device, then the paging controller is adapted to page the mobile wireless communication device through the backup tracking area.

15. A mobile wireless communication device comprising:
a proxy detection unit adapted for detecting a proxy device having a communication connection with a network paging controller and which is adapted for acting as a paging proxy, that is near a present position of the mobile wireless communication device;
a tracking area update request unit adapted for requesting a tracking area update to an area which includes the detected nearby proxy device;
a wireless receiver adapted for communicating with the wide area wireless network via a wide area communication connection including receiving a paging message from a wide area wireless network, which can be selectively activated and deactivated; and
a communication controller unit, which is adapted to selectively deactivate the wide area wireless communication receiver when a tracking area associated with the mobile wireless communication device has been updated to include the detected nearby proxy device; and adapted to selectively activate the wide area wireless communication receiver when the indication of a paging signal from the detected nearby proxy device is received.

16. A mobile wireless communication device in accordance with claim 15, further comprising an interrupt driven sensor for receiving an indication of a paging signal from the detected nearby proxy device.

17. A proxy device for use in conveying an indication of an incoming paging signal, the proxy device comprising:
a wide area wireless network communication unit adapted for communicating with the wide area wireless network;
a local communication unit adapted for interacting with a nearby mobile wireless communication device including receiving an association request including a request for proxy paging services; and
a paging unit adapted for receiving a paging signal alert for an associated mobile wireless communication device via the wide area wireless network communication unit, and forwarding an indication of an incoming paging signal to the associated mobile wireless communication device via the local communication unit;
wherein when an association request including a request for proxy paging services is received, the paging unit of the proxy device is adapted to communicate with the wide area wireless network for purposes of the proxy device becoming associated with the tracking area of the mobile wireless communication device.

18. A proxy device for use in conveying a paging signal in accordance with claim 17, wherein as part of becoming associated with the tracking area of the mobile wireless communication device, the proxy device is validated by the wide area wireless network.

19. A proxy device for use in conveying a paging signal in accordance with claim 17, wherein the wide area wireless network communication unit includes a broadband connection to the wide area wireless network.

20. A proxy device for use in conveying a paging signal in accordance with claim 17, wherein the local communication unit supports an interrupt driven communication connection with the mobile wireless communication device.
